(19) United States
(12) Patent Application Publication
(10) Pub. No.: US 2020/0205628 A1
(43) Pub. Date: Jul. 2, 2020

(54) AUTONOMOUS ELECTRICAL CLEANING APPARATUS

(71) Applicant: TOSHIBA LIFESTYLE PRODUCTS & SERVICES CORPORATION, Kawasaki-shi (JP)

(72) Inventors: Yuuki MARUTANI, Nagakute (JP); Hirokazu IZAWA, Aisai (JP); Kota WATANABE, Owariasahi (JP)

(73) Assignee: TOSHIBA LIFESTYLE PRODUCTS & SERVICES CORPORATION, Kawasaki-shi (JP)

(21) Appl. No.: 16/615,491

(22) PCT Filed: Jun. 8, 2018
(86) PCT No.: PCT/JP2018/021999

§ 371 Date: Nov. 21, 2019

(30) Foreign Application Priority Data
Jun. 8, 2017 (JP) 2017-113522

(51) Int. Cl. A47L 9/28

(52) U.S. Cl. CPC A47L 9/2815; A47L 9/2821; A47L 9/2831; A47L 2201/04; A47L 9/2847; A47L 2201/06; A47L 9/2842

(57) ABSTRACT

An autonomous electrical cleaning apparatus including: an electric blower that generates suction negative pressure on a suction port; a rotating brush disposed at the suction port; a rotating brush driver that drives the rotating brush; a drive wheel that supports a cleaner body, driven by a drive wheel driver, a cleaning-target-surface detector that detects the surface type to be cleaned; and a robot controller that adjusts a controlled variable for any of the suction negative pressure, speed of the rotating brush, rotation direction of the rotating brush, and speed of the drive wheel, based on the surface type to be cleaned. The cleaning-target-surface detector detects the surface type be cleaned at a detection position ahead of the element for which the controlled variable is to be adjusted, and the robot controller adjusts the controlled variable when the element for which the controlled variable is to be changed reaches the detection position.

### FIELD

Embodiments according to the present invention relate to an autonomous electrical cleaning apparatus.

### BACKGROUND

An autonomous electrical cleaning apparatus provided with a camera is known. The autonomous electrical cleaning apparatus uses images taken with the camera for tracking change and movement of the surrounding environment.

### PRIOR ART DOCUMENT

### Patent Document

[Patent Document 1] JP 2006-139753 A

### SUMMARY

### Problems to be Solved by Invention

When cleaning a general room, the autonomous electrical cleaning apparatus moves on and cleans various types of surfaces to be cleaned including carpets, mats, tiles, and flooring. These surfaces to be cleaned have different properties in terms of, for example, easiness of sucking in dust (difficulty in sucking), magnitude of rolling resistance of wheels, magnitude of rotational load (rotational resistance) on a rotating cleaning body such as a brush.

In addition, the autonomous electrical cleaning apparatus moves and performs cleaning while consuming the power of the battery (exclusively, a rechargeable battery).

However, when the autonomous electrical cleaning apparatus moves on different types of surfaces to be cleaned and cleans these surfaces without changing the suction negative pressure, the rotation speed of the rotating brush, and the rotation speed of the driving wheels, such an operation may cause excessive consumption of power on certain types of surfaces to be cleaned and may leave dust on other types of surfaces to be cleaned, resulting in poor cleaning.

For this reason, the present invention provides an autonomous electrical cleaning apparatus that can perform efficient cleaning by appropriately adjusting the strength of suction vacuum pressure, the rotation speed of the rotating brush, and the rotation speed of the driving wheels depending on a type of the surface to be cleaned.

### Means for Solving Problem

To achieve the above object, an autonomous electrical cleaning apparatus including: a cleaner body that can move autonomously on a surface to be cleaned and provides with a suction port on a bottom face; an electric blower that generates suction vacuum pressure on the suction port; a rotating brush disposed at the suction port; a rotating-brush driver that drives the rotating brush; a driving wheel that movably supports the cleaner body; a wheel driver that drives the driving wheel; a cleaning-target-surface detector configured to detect a type of the surface to be cleaned; and a controller configured to adjust a controlled variable of at least one of strength of suction vacuum pressure acting on the suction port, a rotation speed of the rotating brush, a rotation direction of the rotating brush, and a rotation speed of the driving wheel based on the type of the surface to be cleaned detected with the cleaning-target-surface detector. The cleaning-target-surface detector is configured to detect the type of the surface to be cleaned at a detection position ahead of an apparatus-component to be adjusted in the controlled variable among the suction port, the rotating brush, and the driving wheel. The controller is configured to adjust the controlled variable of the apparatus-component when the apparatus-component moves by a distance between the apparatus-component and the detection position of the cleaning-target-surface detector after the type of the surface to be cleaned is changed.

It may be desired that the cleaning-target-surface detector is configured to detect the type of the surface to be cleaned from an area ahead of the cleaner body.

It may be desired that the cleaning-target-surface detector is configured to detect the type of the surface to be cleaned from an area directly below the cleaning body.

It may be desired that the cleaning-target-surface detector includes an image sensor configured to generate an image of the detection position.

It may be desired that the cleaning-target-surface detector includes an infrared sensor configured to detect infrared rays from the detection position.

It may be desired that the controller is configured to adjust the controlled variable of a rotation speed of the electric blower, when a type of a current surface to be cleaned that the suction port faces is different from a type of a next surface to be cleaned to be detected with the cleaning-target-surface detector and the apparatus-component moves by a distance from the detection position of the cleaning-target-surface detector.

It may be desired that the controller is configured to adjust the controlled variable of at least one of a rotation speed and a rotation direction of the rotating-brush driver, when a type of a current surface to be cleaned that the rotating brush contacts is different from a type of a next surface to be cleaned to be detected with the cleaning-target-surface detector and the apparatus-component moves by a distance from the detection position of the cleaning-target-surface detector.

It may be desired that the controller is configured to adjust the controlled variable of a rotation speed of the wheel driver, when a type of a current surface to be cleaned that the driving wheel contacts is different from a type of a next surface to be cleaned to be detected with the cleaning-target-surface detector and the apparatus-component moves by a distance from the detection position of the cleaning-target-surface detector.

It may be desired that the controller is configured to adjust the controlled variable of a rotation speed of the electric blower, when a next surface to be cleaned to be detected with the cleaning-target-surface detector is rougher in terms of surface unevenness than a current surface to be cleaned that the suction port faces and the apparatus-component moves by a distance from the detection position of the cleaning-target-surface detector.

It may be desired that the controller is configured to decrease a rotation speed of the electric blower, when a next surface to be cleaned to be detected with the cleaning-target-surface detector is finer in terms of surface unevenness than a current surface to be cleaned that the suction port faces and the apparatus-component moves by a distance from the detection position of the cleaning-target-surface detector.

It may be desired that the controller is configured to increase the rotation speed of the rotating-brush driver, when the next surface to be cleaned detected is larger in friction coefficient than the current surface to be cleaned and the apparatus-component moves the distance from the detection position of the cleaning-target-surface detector.

It may be desired that the controller is configured to decrease the rotation speed of the rotating-brush driver, when the next surface to be cleaned is smaller in friction coefficient than the current surface to be cleaned and the apparatus-component moves the distance from the detection position of the cleaning-target-surface detector.

It may be desired that the controller is configured to reverse the rotation direction of the rotating brush when the rotating brush reaches the next surface to be cleaned.

It may be desired that the controller is configured to decrease the rotation speed of the wheel driver, when the next surface to be cleaned is larger in friction coefficient than the current surface to be cleaned and the apparatus-component moves the distance from the detection position of the cleaning-target-surface detector.

It may be desired that the controller is configured to increase the rotation speed of the wheel driver, when the next surface to be cleaned is smaller in friction coefficient than the current surface to be cleaned and the apparatus-component moves the distance from the detection position of the cleaning-target-surface detector.

It may be further desired that a pair of right and left second rotating brushes that are provided on the bottom face of the cleaner body and are disposed on respective right and left sides of the suction port; and a pair of right and left second brush drivers that drive the corresponding right and left second rotating brushes. The controller is configured to vary at least one of a rotation speed of each of the second rotating brushes, a rotation direction of each of the second rotating brushes, and an elevation position of each of the second rotating brushes when the second rotating brushes reaches a next surface to be cleaned to be detected with the cleaning-target-surface detector.

### BRIEF DESCRIPTION OF DRAWINGS

FIG. 1 is a perspective view of an autonomous electrical cleaning apparatus according to one embodiment of the present invention as viewed from upper left.

FIG. 2 is a perspective view of the autonomous electrical cleaning apparatus according to the embodiment of the present invention as viewed from lower right.

FIG. 3 is a block diagram of the autonomous electrical cleaning apparatus according to the embodiment of the present invention.

FIG. 4 is a diagram illustrating relationship between the autonomous electrical cleaning apparatus according to the embodiment of the present invention and the detection position of the surface to be cleaned.

FIG. 5 is another diagram illustrating relationship between the autonomous electrical cleaning apparatus according to the embodiment of the present invention and the detection position of the surface to be cleaned.

FIG. 6 is a flowchart illustrating a controlled variable adjustment processing of the autonomous electrical cleaning apparatus according to the embodiment of the present invention.

FIG. 7 is a diagram illustrating one state of the controlled variable adjustment processing of the autonomous electrical cleaning apparatus according to the embodiment of the present invention.

FIG. 8 is a diagram illustrating another state of the controlled variable adjustment processing of the autonomous electrical cleaning apparatus according to the embodiment of the present invention.

FIG. 9 is a diagram illustrating still another state of the controlled variable adjustment processing of the autonomous electrical cleaning apparatus according to the embodiment of the present invention.

FIG. 10 is a diagram illustrating still another state of the controlled variable adjustment processing of the autonomous electrical cleaning apparatus according to the embodiment of the present invention.

FIG. 11 is a diagram illustrating still another state of the controlled variable adjustment processing of the autonomous electrical cleaning apparatus according to the embodiment of the present invention.

FIG. 12 is a diagram illustrating still another state of the controlled variable adjustment processing of the autonomous electrical cleaning apparatus according to the embodiment of the present invention.

FIG. 13 is a diagram illustrating still another state of the controlled variable adjustment processing of the autonomous electrical cleaning apparatus according to the embodiment of the present invention.

FIG. 14 is a diagram illustrating still another state of the controlled variable adjustment processing of the autonomous electrical cleaning apparatus according to the embodiment of the present invention.

FIG. 15 is a diagram illustrating still another state of the controlled variable adjustment processing of the autonomous electrical cleaning apparatus according to the embodiment of the present invention.

FIG. 16 is a diagram illustrating still another state of the controlled variable adjustment processing of the autonomous electrical cleaning apparatus according to the embodiment of the present invention.

FIG. 17 is a diagram illustrating still another state of the controlled variable adjustment processing of the autonomous electrical cleaning apparatus according to the embodiment of the present invention.

FIG. 18 is a diagram illustrating still another state of the controlled variable adjustment processing of the autonomous electrical cleaning apparatus according to the embodiment of the present invention.

### DETAILED DESCRIPTION

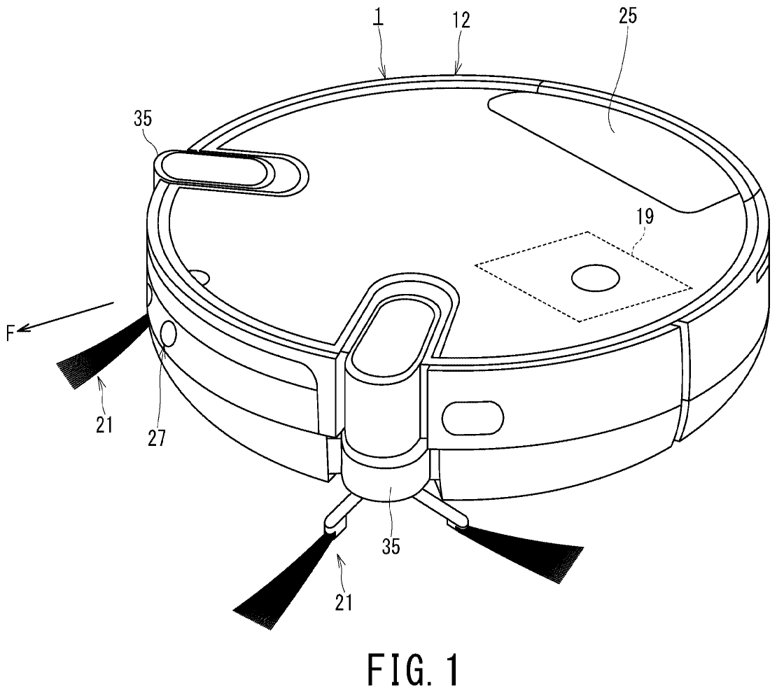

A description will now be given of embodiments of autonomous electrical cleaning apparatuses according to the present invention by referring to FIG. 1 to FIG. 18. In each figure, the same reference signs are given for identical or equivalent components.

The autonomous electrical cleaning apparatus 1 according to the present embodiment is a so-called robot cleaner. The autonomous electrical cleaning apparatus 1 autonomously moves on the surface to be cleaned so as to collect dust on the surface to be cleaned.

FIG. 1 is a perspective view of the autonomous electrical cleaning apparatus according to the embodiment of the present invention as viewed from upper left.

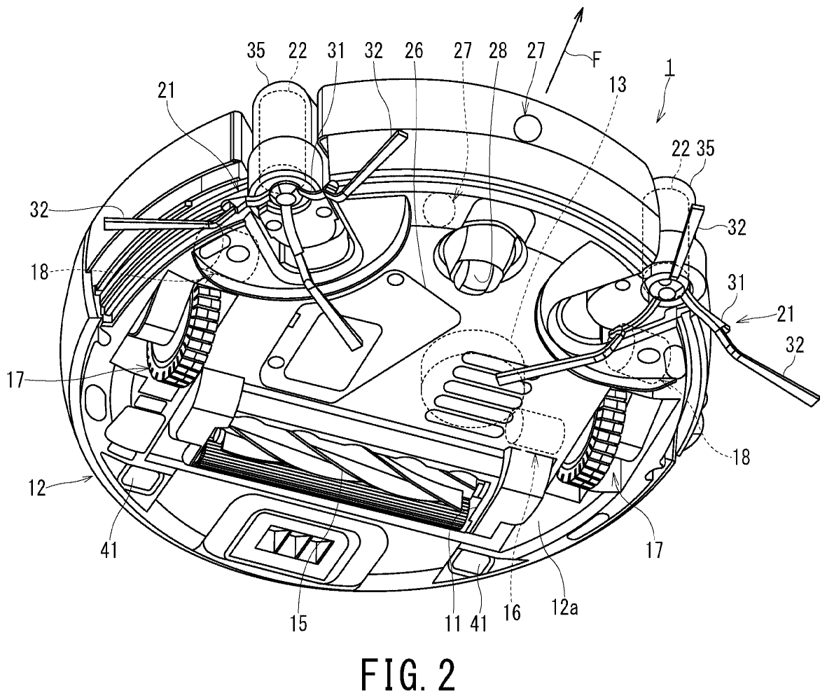

FIG. 2 is a perspective view of the autonomous electrical cleaning apparatus according to the embodiment of the present invention as viewed from front right and from below.

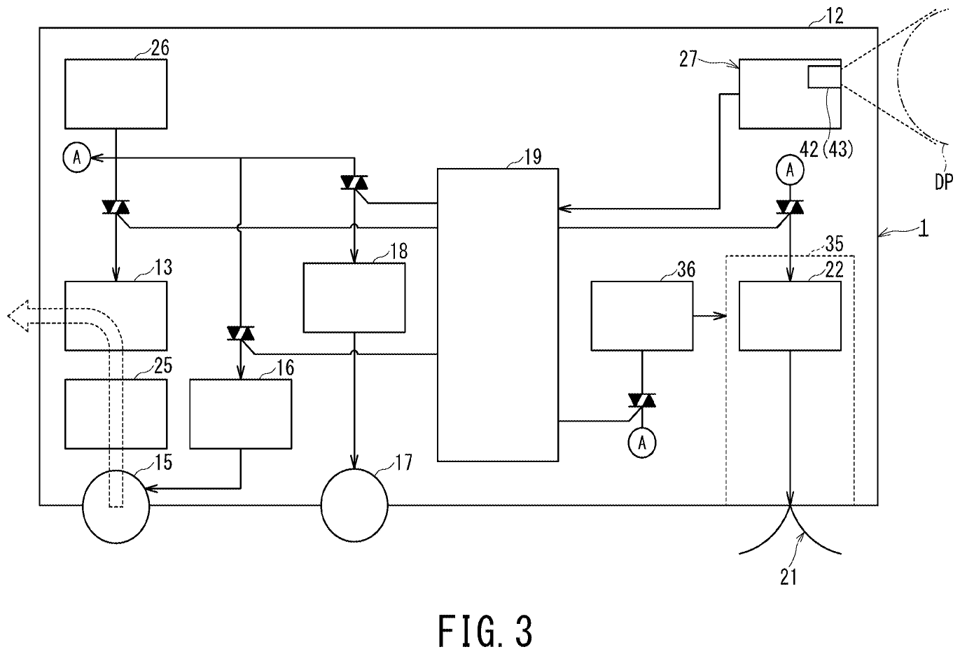

FIG. 3 is a block diagram of the autonomous electrical cleaning apparatus according to the embodiment of the present invention.

The solid arrow F in each of FIG. 1 and FIG. 2 indicates the forward moving direction of the autonomous electrical cleaning apparatus 1. The backward moving direction of the autonomous electrical cleaning apparatus 1 is the opposite direction of the solid arrow F. The width direction of the autonomous electrical cleaning apparatus 1 is the direction orthogonal to the solid arrow F. The right and left of the autonomous electrical cleaning apparatus 1 are the corresponding right and left with respect to the forward moving direction.

A shown in FIG. 1 to FIG. 3, the autonomous electrical cleaning apparatus 1 according to the present embodiment includes: a cleaner body 12 provided with a suction port 11 on its bottom face 12a; an electric blower 13 that generates suction vacuum pressure on the suction port 11; a rotating brush 15 disposed on the suction port 11; a rotating-brush driver 16 that drives the rotating brush 15; driving wheels 17 that movably supports the cleaner body 12; wheel drivers 18 that drive the corresponding driving wheels 17; and a robot controller 19 configured to move the cleaner body 12 autonomously by controlling the electric blower 13, the rotating-brush driver 16, and the wheel drivers 18.

The autonomous electrical cleaning apparatus 1 further includes: a pair of right and left second rotating brushes 21 provided on the bottom face 12a of the cleaner body 12 and disposed on the respective right and left sides of the suction port 11; and a pair of right and left second brush drivers 22 configured to drive the corresponding second rotating brushes 21.

The autonomous electrical cleaning apparatus 1 further includes a dust container 25 detachably provided at the rear of the cleaner body 12 and a rechargeable battery 26 as a power source.

The autonomous electrical cleaning apparatus 1 further includes a cleaning-target-surface detector 27 configured to detect the type (properties) of the surface to be cleaned.

The cleaner body 12 is, for example, a disk-shaped hollow body, and is, for example, a molded article of a synthetic resin.

The suction port 11 is disposed at the center in the width direction of the rear half of the bottom face 12a of the cleaner body 12. The suction port 11 is a rectangular opening that is long in the width direction of the cleaner body 12. The width dimension of the suction port 11 is about ⅔ of the width dimension (i.e., diameter dimension) of the cleaner body 12. The suction port 11 is fluidly connected to the suction side of the electric blower 13 via the dust container 25.

The electric blower 13 includes a motor (not shown) driven by the power of the rechargeable battery 26 and a centrifugal fan (not shown) that is rotated with the motor and generates suction vacuum pressure. The suction vacuum pressure generated with the electric blower 13 acts on the suction port 11 via the dust container 25.

The rotating brush 15 is disposed at the suction port 11. The rotating brush 15 is an axial brush that can rotate around a rotation center extending in the width direction of the cleaner body 12. The rotating brush 15 includes, for example, an elongated shaft (not shown) and a plurality of brushes (not shown) that extend in the radial direction of the shaft and are spirally arranged in the longitudinal direction of the shaft. The rotating brush 15 protrudes from the suction port 11. When the autonomous electrical cleaning apparatus 1 is placed on the surface to be cleaned, the brush contacts the surface to be cleaned. The rotating brush 15 is rotationally driven with the rotating-brush driver 16 so as to pick up and wipe off the dust on the surface to be cleaned with the use of the brush.

The rotating-brush driver 16 is housed in the cleaner body 12. The rotating-brush driver 16 is a motor driven by the power of the rechargeable battery 26.

A pair of right and left driving wheels 17 are disposed on the bottom face 12a of the cleaner body 12. The pair of driving wheels 17 are disposed in front of the suction port 11 and on the corresponding right and left sides of the suction port 11.

The pair of driving wheels 17 protrude from the bottom face 12a of the cleaner body 12. When the cleaner body 12 is placed on the surface to be cleaned, the pair of driving wheels 17 contact the surface to be cleaned. In the center portion in the front-rear direction of the cleaner body 12, the right and left driving wheels 17 are respectively disposed closer to the right side and left side of the bottom face 12a so as not to be directly in front of the suction port 11. The pivot axes of the pair of driving wheels 17 are disposed on the straight line extending along the width direction of the cleaner body 12. The autonomous electrical cleaning apparatus 1 moves forward or backward by rotating the right and left driving wheels 17 in the same direction. The autonomous electrical cleaning apparatus 1 turns clockwise or counterclockwise by rotating the right and left driving wheels 17 in opposite directions.

An autonomous cleaning unit 2 includes a turning wheel 28 that supports the cleaner body 12 in cooperation with the driving wheels 17. The turning wheel 28 is a pivotable driven wheel, which is a so-called caster. The turning wheel 28 is disposed substantially at the center in the width direction of the bottom face 12a of the cleaner body 12 and in the front of the bottom face 12a. In other words, the cleaner body 12 is in contact with and supported by the surface to be cleaned at three points including the pair of driving wheels 17 and the turning wheel 28.

The wheel drivers 18 are provided with a pair of motors that drive the corresponding driving wheels 17 independently by the power of the rechargeable battery 26.

The second rotating brushes 21 are auxiliary cleaning bodies. The pair of the second rotating brushes 21 are disposed on the corresponding right and left sides of the front of the bottom face 12a of the cleaner body 12 so as not to be directly in front of the rotating brush 15. The second rotating brushes 21 scrape dust from the area where the rotating brush 15 does not pass in the process of moving the autonomous electrical cleaning apparatus 1 forward (i.e., scrape dust from the right and left sides of the suction port 11), and sweeps the dust to the suction port 11 or directly in front of the suction port 11. For example, when the autonomous electrical cleaning apparatus 1 moves along a wall, the second rotating brushes 21 scrape the dust on the surface to be cleaned near the wall and sweeps the dust to the suction port 11 or directly in front of the suction port 11.

Each of the second rotating brushes 21 includes: a brush base 31, rotation center of which extends in the vertical direction of the cleaner body 12; and, for example, three linear cleaning bodies 32 radially protruding in the radial direction of the brush base 31.

The respective brush bases 31 are disposed forward of the suction port 11 and the pair of driving wheels 17 and rearward of the turning wheel 28 so as to be closer to the corresponding right and left sides of the cleaner body 12 than the suction port 11.

The linear cleaning bodies 32 radially extend from each brush base 31, for example, in three directions, and are equally spaced in the circumferential direction (i.e., rotational direction) of each brush base 31. Each second rotating brush 21 may have four or more linear cleaning bodies 32 for each brush base 31. Each of the linear cleaning bodies 32 has many bristles as cleaning members on the tip side. The turning of the bristles draws a locus that extends outward beyond the outer peripheral edge of the cleaner body 12.

Each of the second brush drivers 22 includes a rotating shaft (not shown) that protrudes downward and is connected to the brush base 31 of the second rotating brush 21. Each of the second brush drivers 22 rotates the corresponding second rotating brush 21 in the direction by which dust on the surface to be cleaned is scraped toward the suction port 11.

The cleaner body 12 includes housings 35, in each of which the second brush driver 22 is accommodated. The housings 35 can radially project and retract from the center of the cleaner body 12 in the direction horizontal to the cleaner body 12. Normally, the housings 35 protrude from the cleaner body 12 so as to spread the pair of the second rotating brushes 21 to the right and left of the cleaner body 12, and thereby scrape dust from a wider area. For example, when the cleaner body 12 turns and the housings 35 are likely to interfere with the wall or furniture, the housings 35 move toward the center of the cleaner body 12 so as to avoid interference with the wall or furniture.

In addition, the housings 35 move in the vertical direction of the cleaner body 12. For example, when the cleaner body 12 rides up on the carpet from the flooring, the autonomous electrical cleaning apparatus 1 raises the housings 35 to avoid the brushes of each second rotating brush 21 from getting in between the carpet and the flooring. The raising and lowering of the housings 35 are performed by the housing up-and-down driver 36. The housing up-and-down driver 36 is a motor driven by the power of the rechargeable battery 26.

The robot controller 19 includes a microprocessor (not shown) and a memory (not shown) for storing, for example, parameters, and various computation programs to be executed with the microprocessor. The robot controller 19 is electrically connected to the electric blower 13, the rotating-brush driver 16, the wheel drivers 18, the second brush drivers 22, and the housing up-and-down driver 36.

The robot controller 19 controls the electric blower 13, the rotating-brush driver 16, the wheel drivers 18, and the second brush drivers 22 according to an autonomous running program to be executed by the microprocessor so as to autonomously moves the autonomous electrical cleaning apparatus 1 on the surface to be cleaned, and thereby cleans the surface to be cleaned.

In detail, the robot controller 19 adjusts the strength of the suction vacuum pressure acting on the suction port 11 by increasing or decreasing the input of the electric blower 13. The robot controller 19 adjusts the rotation speed of the rotating brush 15 by increasing or decreasing the input of the rotating-brush driver 16. The robot controller 19 adjusts the rotation speed of the driving wheels 17 by increasing or decreasing the input of the wheel drivers 18, and thereby adjusts the moving speed and moving direction of the autonomous electrical cleaning apparatus 1. The robot controller 19 adjusts the rotation speed of the second rotating brushes 21 by increasing or decreasing the input of the second brush drivers 22. The robot controller 19 raises or lowers the housings 35 by increasing or decreasing the input of the housing up-and-down driver 36, and thereby raises or lowers the second rotating brushes 21.

On the basis of the type (properties) of the surface to be cleaned to be detected with the cleaning-target-surface detector 27, the robot controller 19 adjusts a controlled variable of at least one of the suction vacuum pressure acting on the suction port 11, the rotation speed of the rotating brush 15, the rotation direction of the rotating brush 15, and the rotation speed of the driving wheels 17. In other words, on the basis of the type of the surface to be cleaned to be detected with the cleaning-target-surface detector 27, the robot controller 19 adjusts the controlled variable of at least one of the rotation speed of the electric blower 13, the rotation speed of the rotating-brush driver 16, and the rotation speed of the wheel drivers 18.

Further, the robot controller 19 may adjust at least one of the rotation speed of the second rotating brushes 21, the rotation direction of the second rotating brushes 21, and the elevation position of the second rotating brushes 21 on the basis of the type (properties) of the surface to be cleaned to be detected with the cleaning-target-surface detector 27. In other words, on the basis of the type of the surface to be cleaned to be detected with the cleaning-target-surface detector 27, the robot controller 19 may adjust the rotation speed of the second brush drivers 22, the rotation direction of the second brush drivers 22, and the elevation positions of the housings 35.

The dust container 25 accumulates dust to be sucked from the suction port 11 by the suction vacuum pressure that is generated with the electric blower 13. The dust container 25 is provided with a filter configured to filter and collect dust from the air and a separation device that separates dust from air and accumulate the dust by inertial separation, such as centrifugal separation (cyclone separation) and/or straight-flow type separation (in which dust is separated from air by difference in inertial force between the dust and air going straight through the air path). The dust container 25 is disposed behind the suction port 11 and at the rear of the cleaner body 12.

The rechargeable battery 26 supplies power to the electric blower 13, the rotating-brush driver 16, the wheel drivers 18, the second brush drivers 22, and the robot controller 19. The rechargeable battery 26 is disposed, for example, between the turning wheel 28 and the suction port 11. The rechargeable battery 26 is electrically connected to a pair of charging terminals 41 disposed on the bottom face 12a of the cleaner body 12.

After cleaning the room, the autonomous electrical cleaning apparatus 1 returns to a charging stand (not shown) disposed at an appropriate place on the surface to be cleaned, connects the charging terminals 41 to the charging electrodes (not shown) of the charging stand, and then waits for the start of the next cleaning operation while charging the rechargeable battery 26.

The cleaning-target-surface detector 27 is disposed on at least one of the front face of the cleaner body 12 (as indicated by the solid line with the reference sign 27 in FIG. 1 and FIG. 2) and the bottom face 12a of the cleaner body 12 (as indicated by the broken line with the reference sign 27 in FIG. 2).

The cleaning-target-surface detector 27 detects the type of the surface to be cleaned such as carpets, mats, floorings, and tiles. The cleaning-target-surface detector 27 includes at least one of an image sensor 42 for taking images of the detection position DP and an infrared sensor 43 for detecting infrared rays from the detection position DP. The cleaning-target-surface detector 27 analyzes the images taken with the image sensor 42 or analyzes the infrared rays detected with the infrared sensor 43 so as to distinguish or identify the type of the surface to be cleaned. This distinguishment or identification of the surface to be cleaned is processed by a known image processing technique. Additionally or alternatively, the distinguishment or identification of the surface to be cleaned may be processed by the robot controller 19.

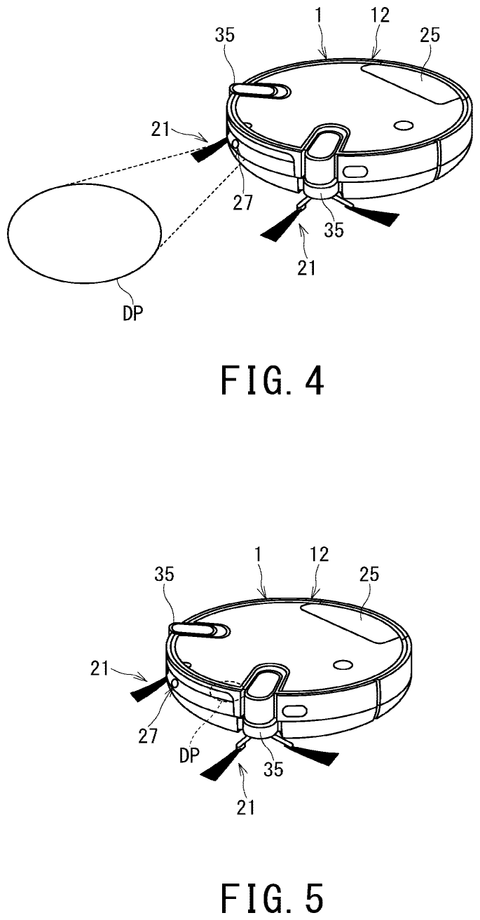

FIG. 4 and FIG. 5 are diagrams illustrating the relationship between the autonomous electrical cleaning apparatus according to the embodiment of the present invention and the detection position of the surface to be cleaned.

As shown in FIG. 4 and FIG. 5, when the cleaning-target-surface detector 27 of the autonomous electrical cleaning apparatus 1 according to the present embodiment is disposed on the front of the cleaner body 12, the cleaning-target-surface detector 27 detects the type of the surface to be cleaned in the area ahead of the cleaner body 12 (FIG. 4). When the cleaning-target-surface detector 27 is provided on the bottom face 12a of the cleaner body 12, the cleaning-target-surface detector 27 detects the type of the surface to be cleaned directly below the cleaner body 12 (FIG. 5).

In addition, the cleaning-target-surface detector 27 detects the type of the surface to be cleaned from the detection position DP ahead of the apparatus-component that is adjusted in controlled variable among the suction port 11, the rotating brush 15, and the driving wheels 17.

Specifically, in the case of adjusting the strength of the suction vacuum pressure acting on the suction port 11 by adjusting the rotation speed of the electric blower 13, the cleaning-target-surface detector 27 detects the type of the surface to be cleaned at least from the detection position DP ahead of the suction port 11.

In addition, in the case of adjusting the rotation speed of the rotating brush 15 by adjusting the rotation speed of the rotating-brush driver 16, the cleaning-target-surface detector 27 detects the type of the surface to be cleaned from the detection position DP in front of at least the rotating brush 15, and further from the detection position DP in front of the suction port 11.

Additionally, in the case of changing the rotation direction of the rotating brush 15 by changing the rotation direction of the rotating-brush driver 16, the cleaning-target-surface detector 27 detects the type of the surface to be cleaned from the detection position DP in front of at least the rotating brush 15, and further from the detection position DP in front of the suction port 11.

Moreover, in the case of adjusting the rotation speed of the driving wheels 17 by adjusting the rotation speed of the wheel drivers 18, the cleaning-target-surface detector 27 detects the type of the surface to be cleaned from the detection position DP in front of at least the driving wheels 17.

The cleaning-target-surface detector 27 according to the present embodiment detects the type of the surface to be cleaned from the detection position DP ahead of the suction port 11, the rotating brush 15, and the driving wheels 17.

Further, the second rotating brushes 21 may be included in the apparatus-component to be adjusted in the controlled variable. When at least one of the rotation speed of the second brush drivers 22, the rotation direction of the second brush drivers 22, and the elevation positions of the housings 35 is adjusted on the basis of the type of the surface to be cleaned detected with the cleaning-target-surface detector 27 (i.e., when at least one of the rotation speed, the rotation direction, and the elevation positions of the second rotating brushes 21 is adjusted on the basis of the type of the surface to be cleaned detected with the cleaning-target-surface detector 27), the cleaning-target-surface detector 27 detects the type of the surface to be cleaned from the detection position DP ahead of the second rotating brushes 21.

Note that “the detection position DP” is a place or range that is reflected in the image(s) taken with image sensor 42 and is a place or range from which the infrared sensor 43 detects the infrared rays. The “detection position” is set at a place where the autonomous electrical cleaning apparatus 1 passes in the process of moving forward.

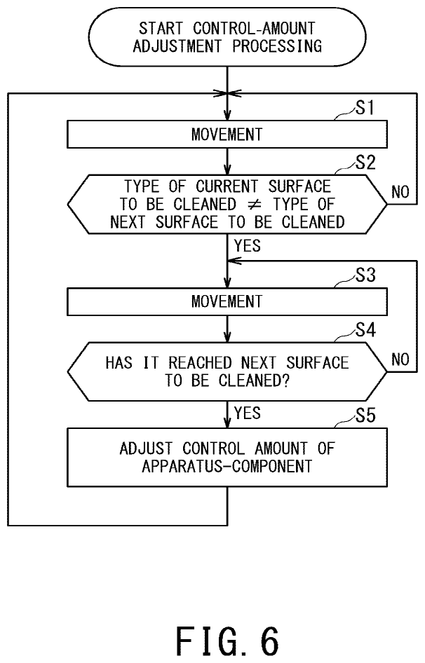

FIG. 6 is a flowchart illustrating the controlled variable adjustment processing of the autonomous electrical cleaning apparatus according to the embodiment of the present invention.

As shown in FIG. 6, regardless of whether the detection position DP of the cleaning-target-surface detector 27 is in the area ahead of the cleaner body 12 or directly below the cleaner body 12, the robot controller 19 of the autonomous electrical cleaning apparatus 1 according to the present embodiment adjusts the controlled variable of the apparatus-component in the step S5 when the apparatus-component moves the distance between the detection position DP of the cleaning-target-surface detector 27 and the apparatus-component in the process of movement of the cleaner body 12 (from the steps S1 to S5). In other words, after the cleaning-target-surface detector 27 detects the type of the surface to be cleaned in the process of the movement of the cleaner body 12, the robot controller 19 adjusts the controlled variable of the apparatus-component when the apparatus-component moves the distance between the detection position DP of the cleaning-target-surface detector 27 and the apparatus-component (i.e., the distance between the apparatus-component and the detection position DP in the forward moving direction).

For simplifying the following description, “the current surface to be cleaned” is defined as the surface to be cleaned which the apparatus-component among the suction port 11, the rotating brush 15, and the driving wheels 17 currently faces. Further, “the next surface to be cleaned” is defined as the surface to be cleaned at the detection position DP to be detected with the cleaning-target-surface detector 27. The robot controller 19 compares the type of the current surface to be cleaned with the type of the next surface to be cleaned in the step S2. When the type of the current surface to be cleaned differs from the type of the next surface to be cleaned (YES in the step S2), the robot controller 19 adjusts the controlled variable of the apparatus-component in the step S5 when the apparatus-component reaches the next surface to be cleaned in the step S4 subsequent to the step S3.

The above-described “when the apparatus-component reaches the next surface to be cleaned” is substantially the same as “when the apparatus-component moves the distance between the detection position DP of the cleaning-target-surface detector 27 and the apparatus-component”, and is also substantially the same as “when the apparatus-component moves the distance between the detection position DP of the cleaning-target-surface detector 27 and the apparatus-component”. The type of the current surface to be cleaned is replaced by the type of the next surface to be cleaned that has already been detected, in the three cases including: when the autonomous electrical cleaning apparatus 1 moves and the apparatus-component reaches the next surface to be cleaned, type of which has already been detected; when the autonomous electrical cleaning apparatus 1 moves so as to cause the apparatus-component to move the distance between the detection position DP of the cleaning-target-surface detector 27 and the apparatus-component; or when the autonomous electrical cleaning apparatus 1 moves so as to cause the apparatus-component to move the distance between the detection position DP of the cleaning-target-surface detector 27 and the apparatus-component.

When the type of the current surface to be cleaned that the apparatus-component faces is the same as the type of the next surface to be cleaned detected with the cleaning-target-surface detector 27 (No in the step S2), the robot controller 19 continues moving while maintaining the controlled variable of the apparatus-component (i.e., without changing it) in the step S1.

Even if the type of the current surface to be cleaned (that the apparatus-component faces) differs from the type of the next surface to be cleaned to be detected with the cleaning-target-surface detector 27 (YES in the step S2), the robot controller 19 continues moving while maintaining the controlled variable of the apparatus-component (i.e., without changing it) in the step S3, until the apparatus-component reaches the next surface to be cleaned. The determination as to whether the apparatus-component reaches the next surface to be cleaned depends on the difference between the movement distance of the autonomous electrical cleaning apparatus 1 (corresponding to the number of rotations of the driving wheels 17) and the distance from the apparatus-component to the cleaning-target-surface detector 27. The distance from the apparatus-component to the cleaning-target-surface detector 27 is determined in advance.

Specifically, When the suction vacuum pressure acting on the suction port 11 is included in the controlled variable of the apparatus-component and the type of the current surface to be cleaned (that the suction port 11 faces) differs from the type of the next surface to be cleaned (that is detected with the cleaning-target-surface detector 27), the robot controller 19 adjusts the rotation speed of the electric blower 13 when the suction port 11 reaches the next surface to be cleaned.

When the rotation speed or rotation direction of the rotating brush 15 is included in the controlled variable of the apparatus-component and the type of the current surface to be cleaned (that the rotating brush 15 contacts) differs from the type of the next surface to be cleaned (that is detected with the cleaning-target-surface detector 27), the robot controller 19 adjusts at least one of the rotation speed and the rotation direction of the rotating-brush driver 16 when the rotating-brush driver 16 reaches the next surface to be cleaned.

When the rotation speed of the driving wheels 17 is included in the controlled variable of the apparatus-component and the type of the current surface to be cleaned (that the driving wheels 17 face) differs from the type of the next surface to be cleaned (that is detected with the cleaning-target-surface detector 27), the robot controller 19 adjusts the rotation speed of the wheel drivers 18 when the wheel drivers 18 reach the next surface to be cleaned.

When the rotation speed of the second rotating brushes 21 is included in the controlled variable of the apparatus-component and the type of the current surface to be cleaned (that the second rotating brushes 21 face) differs from the type of the next surface to be cleaned (that is detected with the cleaning-target-surface detector 27), the robot controller 19 adjusts the rotation speed of the second brush drivers 22 when the second rotating brushes 21 reach the next surface to be cleaned.

When the rotation direction of the second rotating brushes 21 is included in the controlled variable of the apparatus-component and the type of the current surface to be cleaned (that the second rotating brushes 21 face) differs from the type of the next surface to be cleaned (that is detected with the cleaning-target-surface detector 27), the robot controller 19 changes the rotation direction of the second brush drivers 22 when the second rotating brushes 21 reach the next surface to be cleaned.

When the elevation position of each second rotating brush 21 is included in the controlled variable of the apparatus-component and the type of the current surface to be cleaned (that the second rotating brushes 21 contact) differs from the type of the next surface to be cleaned (that is detected with the cleaning-target-surface detector 27), the robot controller 19 changes the elevation position of each housing 35 when the second rotating brushes 21 reach the next surface to be cleaned.

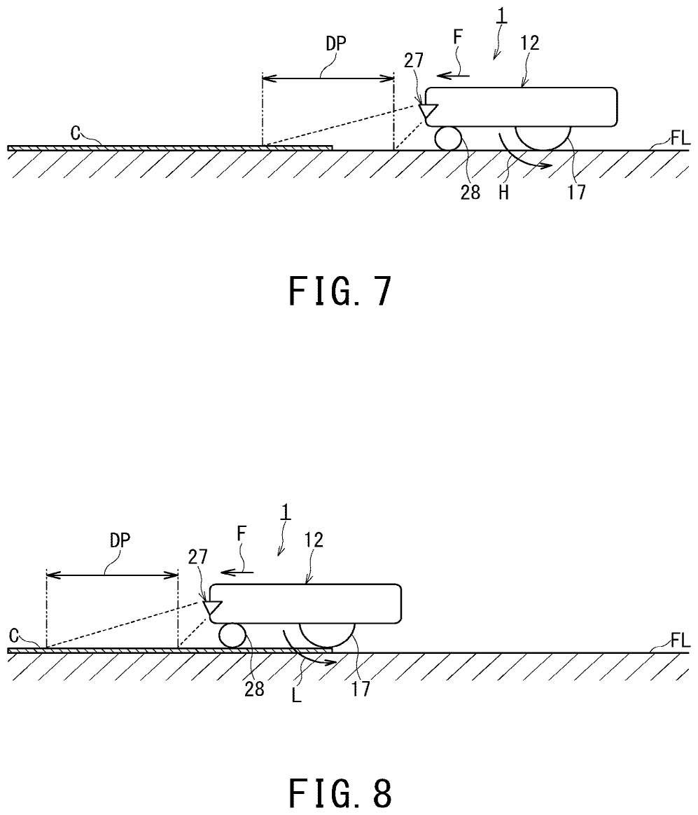

Each of FIG. 7 to FIG. 14 is a diagram illustrating a state of the controlled variable adjustment processing of the autonomous electrical cleaning apparatus according to the embodiment of the present invention.

Each of FIG. 7 to FIG. 10 illustrates the case where the detection position DP of the cleaning-target-surface detector 27 is set ahead of the cleaner body 12.

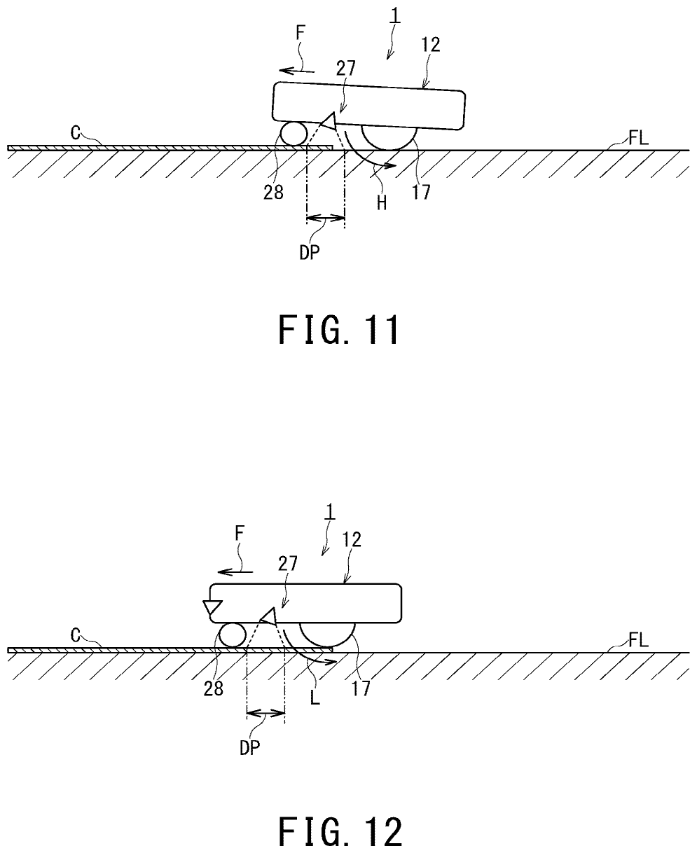

Each of FIG. 11 and FIG. 14 illustrates the case where the detection position DP of the cleaning-target-surface detector 27 is set directly below the cleaner body 12.

As shown in FIG. 7 and FIG. 11, the autonomous electrical cleaning apparatus 1 according to the present embodiment cleans the flooring FL by setting the electric blower 13 to the low rotation mode, setting the rotating brush 15 to the low rotation mode, and setting the driving wheels 17 to the high rotation mode (solid arrow H).

When the autonomous electrical cleaning apparatus 1 approaches the edge of the carpet C and the carpet C is reflected in the field of view of the cleaning-target-surface detector 27 (i.e., reflected in the detection position DP), the robot controller 19 determines that the next surface to be cleaned is different in property from the current surface to be cleaned.

As shown in FIG. 8 and FIG. 12, when the autonomous electrical cleaning apparatus 1 according to the present embodiment reaches the carpet C that is the next surface to be cleaned, the autonomous electrical cleaning apparatus 1 cleans the carpet C by adjusting the electric blower 13 to the high rotation mode, adjusting the rotating brush 15 to the high rotation mode, and adjusting the driving wheels 17 to the low rotation mode (solid arrow L).

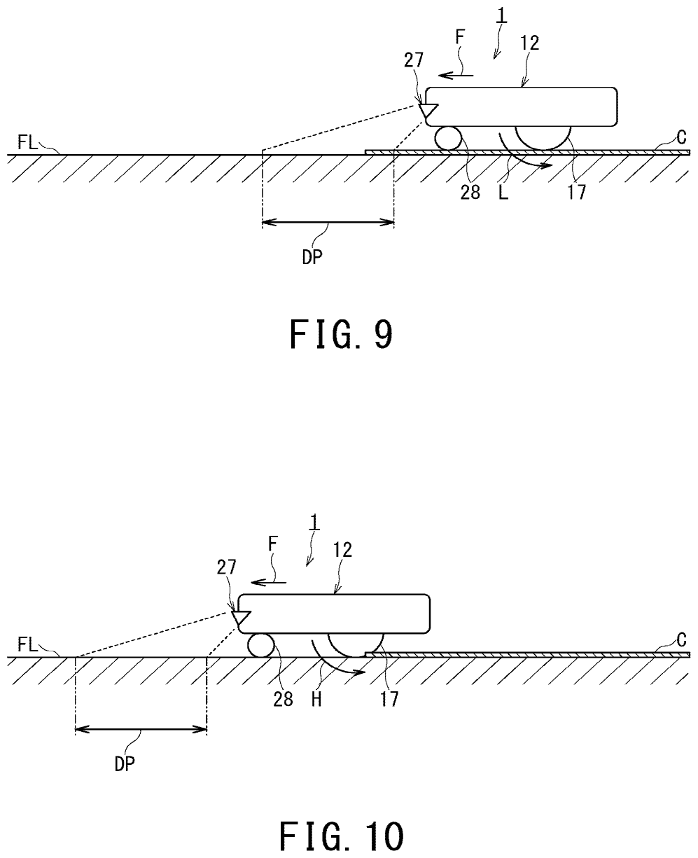

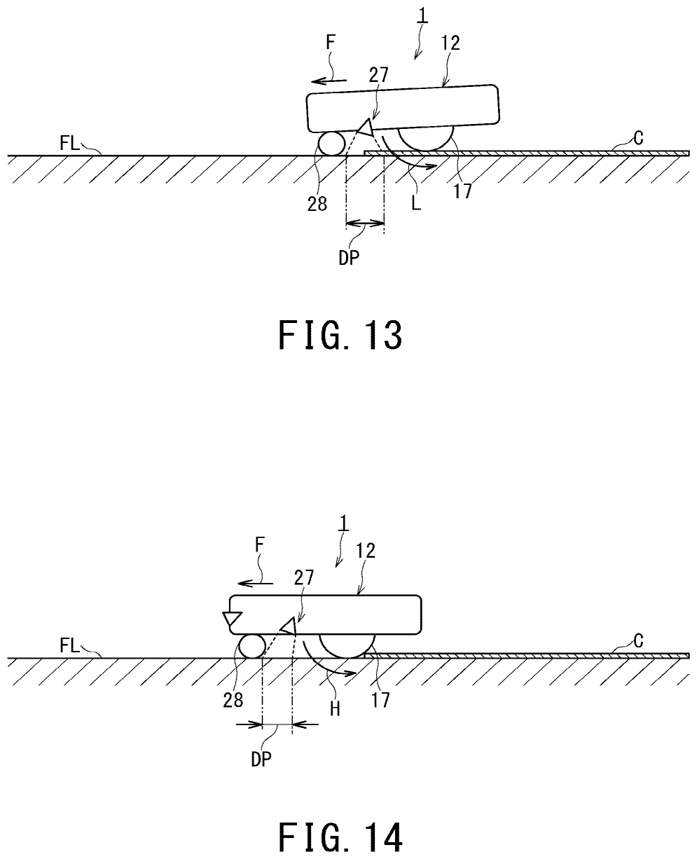

In addition, as shown in FIG. 9 and FIG. 13, the autonomous electrical cleaning apparatus 1 according to the present embodiment cleans the carpet C by adjusting the electric blower 13 to the high rotation mode, adjusting the rotating brush 15 to the high rotation mode, and adjusting the driving wheels 17 to the low rotation mode (solid arrow L).

When the autonomous electrical cleaning apparatus 1 approaches the edge of the carpet C and the flooring FL is reflected in the field of view of the cleaning-target-surface detector 27 (i.e., reflected in the detection position DP), the robot controller 19 determines that the next surface to be cleaned is different in property from the current surface to be cleaned.

As shown in FIG. 10 and FIG. 14, when the autonomous electrical cleaning apparatus 1 according to the present embodiment reaches the flooring FL that is the next cleaning surface, the autonomous electrical cleaning apparatus 1 cleans the flooring FL by adjusting the electric blower 13 to the low rotation mode, adjusting the rotating brush 15 to the low rotation mode, and adjusting the driving wheels 17 to the high rotation mode (solid arrow H).

In other words, even if the autonomous electrical cleaning apparatus 1 determines that the next surface to be cleaned is different in property from the current surface to be cleaned, the autonomous electrical cleaning apparatus 1 does not directly adjusts the controlled variable of the apparatus-component but adjusts the controlled variable after moving by the distance between the current surface to be cleaned and the next surface to be cleaned.

The carpet C is harder to remove dust than the flooring FL. Thus, in the case of cleaning the carpet C, the autonomous electrical cleaning apparatus 1 sets the electric blower 13 and the rotating brush 15 to the high rotation mode and sets the driving wheels 17 to the low rotation mode so as to slow the moving speed and reliably remove dust.

The flooring FL is easier to remove dust than the carpet C. Thus, in the case of cleaning the flooring FL, the autonomous electrical cleaning apparatus 1 sets the electric blower 13 and the rotating brush 15 to the low rotation mode and sets the driving wheels 17 to the high rotation mode so as to accelerate the moving speed and perform cleaning quickly while suppressing the consumption of power.

As described above, the autonomous electrical cleaning apparatus 1 suitably balances the dust removal power and the power consumption by adjusting the controlled variable of the apparatus-component depending on the type of the surface to be cleaned.

The types of surfaces to be cleaned or the properties of surfaces to be cleaned include, for example, carpets, mats, floorings, and tiles. These cleaning surfaces are easy to remove dust in the order of carpets, mats, and floorings. This difference in easiness of cleaning is attributable to the difference in property, for example, surface irregularities become finer in the order of carpets, mats, and floorings, and the friction coefficient and rolling resistance decrease in the order of carpets, mats, and floorings.

For this reason, When the next surface to be cleaned (that is detected with the cleaning-target-surface detector 27) is rougher in terms of surface unevenness than the current surface to be cleaned that the suction port 11 faces, the robot controller 19 increases the rotation speed of the electric blower 13 when the suction port 11 reaches the rough surface to be cleaned (i.e., reaches the next cleaning surface).

When the next surface to be cleaned (that is be detected with the cleaning-target-surface detector 27) is finer in terms of surface unevenness than the current surface to be cleaned that the suction port 11 faces, the robot controller 19 decreases the rotation speed of the electric blower 13 when the suction port 11 reaches the surface to be cleaned with fine irregularities (i.e., reaches the next surface to be cleaned).

When the next surface to be cleaned (that is detected with the cleaning-target-surface detector 27) is larger in friction coefficient than the current surface to be cleaned that the rotating brush 15 contacts, the robot controller 19 increases the rotation speed of the rotating-brush driver 16 when the rotating brush 15 reaches the surface to be cleaned having a large friction coefficient (i.e., reaches the next surface to be cleaned).

When the next surface to be cleaned (that is detected with the cleaning-target-surface detector 27) is smaller in friction coefficient than the current surface to be cleaned that the rotating brush 15 contacts, the robot controller 19 decreases the rotation speed of the rotating-brush driver 16 when the rotating brush 15 reaches the surface to be cleaned with a small friction coefficient (i.e., reaches the next surface to be cleaned).

Further, the robot controller 19 may reverse the rotation direction of the rotating brush 15 when the rotating brush 15 reaches the next surface to be cleaned. The driving force of the cleaner body 12 can be assisted by rotating the rotating brush 15 in the same direction as the driving wheels 17, and the driving force of the cleaner body 12 can be weakened by rotating the rotating brush 15 in the direction opposite to the rotation direction of the driving wheels 17.

When the next surface to be cleaned (that is detected with the cleaning-target-surface detector 27) is larger in friction coefficient than the current surface to be cleaned that the driving wheels 17 contact, the robot controller 19 decreases the rotation speed of the wheel drivers 18 when the driving wheels 17 reach the surface to be cleaned having a large friction coefficient (i.e., reach the next surface to be cleaned).

When the next surface to be cleaned (that is detected with the cleaning-target-surface detector 27) is smaller in friction coefficient than the current surface to be cleaned that the driving wheels 17 contact, the robot controller 19 increases the rotation speed of the wheel drivers 18 when the driving wheels 17 reach the surface to be cleaned having a small friction coefficient (i.e., reach the next surface to be cleaned).

When the next surface to be cleaned (that is detected with the cleaning-target-surface detector 27) is larger in friction coefficient than the current surface to be cleaned that the second rotating brushes 21 contact, the robot controller 19 increases the rotation speed of the second brush drivers 22 when the second rotating brushes 21 reach the surface to be cleaned having a large friction coefficient (i.e., reach the next surface to be cleaned).

When the next surface to be cleaned (that is detected with the cleaning-target-surface detector 27) is smaller in friction coefficient than the current surface to be cleaned that the second rotating brushes 21 contact, the robot controller 19 decreases the rotation speed of the second brush drivers 22 when the second rotating brushes 21 reach the surface to be cleaned having a small friction coefficient (i.e., reach the next surface to be cleaned).

Further, the robot controller 19 may reverse the rotation direction of the second rotating brushes 21 when the second rotating brushes 21 reach the detection position DP of the cleaning-target-surface detector 27.

The strength relationship, magnitude relationship, and relationship of the rotational direction of the controlled variable of these apparatus-components is appropriately set depending on the easiness (or difficulty) of removing the dust and the properties of the surface to be cleaned with the use of the autonomous electrical cleaning apparatus 1. In other words, depending on the estimated difference in property between the current surface to be cleaned and the next surface to be cleaned, the method of adjusting the controlled variable of the apparatus component may be opposited (i.e., the strength relationship may be oppositely set, the magnitude relationship may be oppositely set, and the direction relationship may be oppositely set).

In addition, tiles are as easy to remove dust as floorings.

The autonomous electrical cleaning apparatus 1 may adjust the controlled variable of each of the electric blower 13, the rotating brush 15, the driving wheels 17, and the second rotating brush 21 simultaneously or individually (separately) in the order of reaching the next surface to be cleaned.

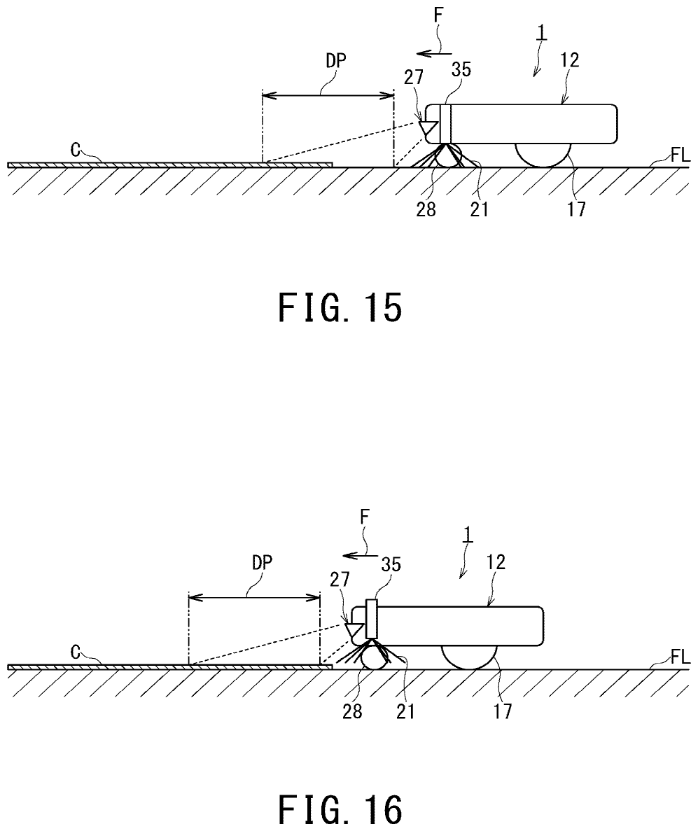

Each of FIG. 15 to FIG. 18 is a diagram illustrating a state of the controlled variable adjustment processing of the autonomous electrical cleaning apparatus according to the embodiment of the present invention.

As shown in FIG. 15, the autonomous electrical cleaning apparatus 1 according to the present embodiment cleans the flooring FL by adjusting each second rotating brush 21 to a low position.

When the autonomous electrical cleaning apparatus 1 approaches the edge of the carpet C and the carpet C is reflected in the field of view of the cleaning-target-surface detector 27 (i.e., reflected in the detection position DP), the robot controller 19 determines that the next surface to be cleaned is different in property from the current surface to be cleaned.

As shown in FIG. 16, when reaching the carpet C that is the next surface to be cleaned, the autonomous electrical cleaning apparatus 1 according to the present embodiment adjusts the position of each second rotating brush 21 to a high position and intrudes into the carpet C.

A rug such as the carpet C and the mat generates a step with the flooring FL. If the autonomous electrical cleaning apparatus 1 intrudes into the carpet C while cleaning the flooring FL by setting each second rotating brush 21 to the low position, there is a possibility that the tip of the brush of each second rotating brush 21 gets caught in the step between the carpet C and the flooring FL or intrudes between the carpet C and the flooring FL. For this reason, when the autonomous electrical cleaning apparatus 1 advances onto the carpet C from the flooring FL, each second rotating brush 21 adjusts the position of each second rotating brush 21 to a low position to prevent the second rotating brushes 21 from being caught and intruding.

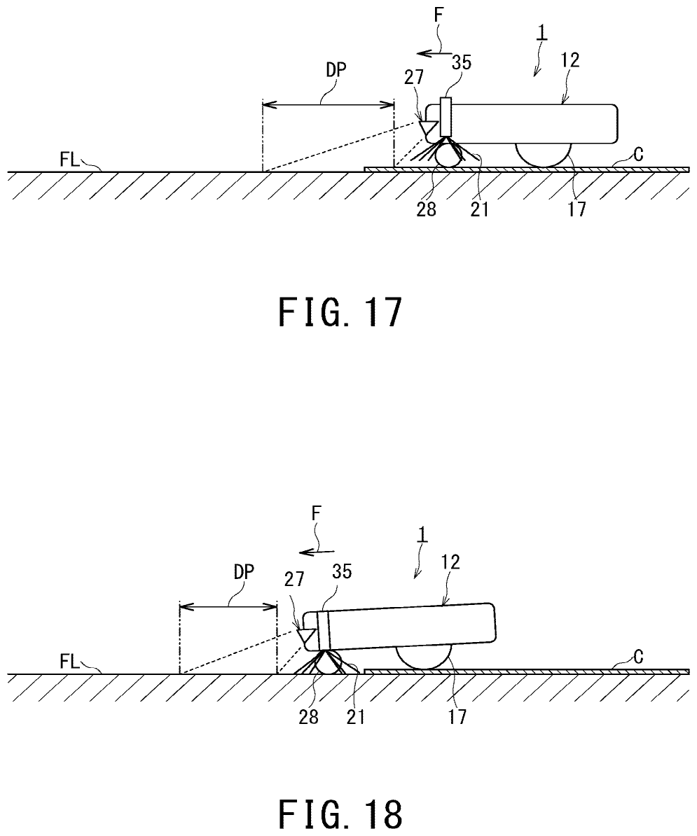

As shown in FIG. 17, the autonomous electrical cleaning apparatus 1 according to the present embodiment cleans the carpet C by adjusting each second rotating brush 21 to a high position.

On a rug such as the carpet C and the mat, the dust collection effect by the second rotating brushes 21 is small. Thus, when cleaning the carpet C, the autonomous electrical cleaning apparatus 1 adjusts each second rotating brush 21 to a high position and stops the rotation.

As shown in FIG. 18, when the automatic electrical cleaning apparatus 1 according to the present embodiment reaches the flooring FL that is the next surface to be cleaned, the automatic electrical cleaning apparatus 1 adjusts the position of each second rotating brush 21 to a low position so as to scrape the dust on the flooring FL.

After the type of the surface to be cleaned is changed, the autonomous electrical cleaning apparatus 1 according to the present embodiment adjusts the controlled variable of the apparatus-component (for example, the electric blower 13, the rotating brush 15, the driving wheels 17, or the second rotating brushes 21) when the apparatus-component moves the distance between the apparatus-component and the detection position DP of cleaning-target-surface detector 27, consequently, the autonomous electrical cleaning apparatus 1 can appropriately adjust, for example, the strength of the suction vacuum pressure, the rotation speed of the rotating brush 15, the rotation speed of the driving wheels 17 depending on the type of the surface to be cleaned, and thereby can appropriately balance the dust removal power and the power consumption. In other words, in the autonomous electrical cleaning apparatus 1, wasteful power consumption is decreased and the efficiency is improved.

The autonomous electrical cleaning apparatus 1 according to the present embodiment detects the type of the surface to be cleaned in the area ahead of the cleaner body 12, consequently, the autonomous electrical cleaning apparatus 1 can readily secure processing time for executing pre-processing in accordance with the state of the moving direction, for example, processing time for analyzing and recognizing images.

Further, the autonomous electrical cleaning apparatus 1 according to the present embodiment detects the type of the surface to be cleaned in the area directly below the cleaner body 12, consequently, even if obstacles are placed on its moving path, the autonomous electrical cleaning apparatus 1 can accurately perform the controlled variable adjustment processing in the immediate vicinity of the current position without being disturbed by these obstacles.

Since the autonomous electrical cleaning apparatus 1 according to the present embodiment includes the image sensor 42 configured to acquire images of the detection position DP, the type of the surface to be cleaned can be accurately identified by image analysis.

Since the autonomous electrical cleaning apparatus 1 according to the present embodiment includes the infrared sensor 43 configured to detect the infrared rays from the detection position DP, the type of the surface to be cleaned can be identified with an inexpensive configuration.

As described above, the autonomous electrical cleaning apparatus 1 according to the present embodiment can appropriately adjust, for example, the strength of the suction vacuum pressure, the rotation speed of the rotating brush 15, the rotation speed of the driving wheels 17 depending on the type of the surface to be cleaned, and thus can perform efficient cleaning.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

### REFERENCE SIGNS LIST

1 autonomous electrical cleaning apparatus
11 suction port
12 cleaner body
12a bottom face
13 electric blower
15 rotating brush
16 rotating-brush driver
17 driving wheel
18 wheel driver
19 robot controller
21 second rotating brush
22 second brush driver
25 dust container
26 rechargeable battery
27 cleaning-target-surface detector
28 turning wheel
31 brush base
32 linear cleaning body
35 housing
36 housing up-and-down driver
41 charging terminal
42 image sensor
43 infrared sensor

1: An autonomous electrical cleaning apparatus comprising:
a cleaner body that can move autonomously on a surface to be cleaned and provides with a suction port on a bottom face;
an electric blower that generates suction vacuum pressure on the suction port;
a rotating brush disposed at the suction port;
a rotating-brush driver that drives the rotating brush;
a driving wheel that movably supports the cleaner body;
a wheel driver that drives the driving wheel;
a cleaning-target-surface detector configured to detect a type of the surface to be cleaned; and
a controller configured to adjust a controlled variable of at least one of strength of suction vacuum pressure acting on the suction port, a rotation speed of the rotating brush, a rotation direction of the rotating brush, and a rotation speed of the driving wheel based on the type of the surface to be cleaned detected with the cleaning-target-surface detector,
wherein the cleaning-target-surface detector is configured to detect the type of the surface to be cleaned at a detection position ahead of an apparatus-component to be adjusted in the controlled variable among the suction port, the rotating brush, and the driving wheel, and
wherein the controller is configured to adjust the controlled variable of the apparatus-component when the apparatus-component moves by a distance between the apparatus-component and the detection position of the cleaning-target-surface detector after the type of the surface to be cleaned is changed.

2: The autonomous electrical cleaning apparatus according to claim 1,
wherein the cleaning-target-surface detector is configured to detect the type of the surface to be cleaned from an area ahead of the cleaner body.

3: The autonomous electrical cleaning apparatus according to claim 1,
wherein the cleaning-target-surface detector is configured to detect the type of the surface to be cleaned from an area directly below the cleaning body.

4: The autonomous electrical cleaning apparatus according to claim 1,
wherein the cleaning-target-surface detector includes an image sensor configured to generate an image of the detection position.

5: The autonomous electrical cleaning apparatus according to claim 1,
wherein the cleaning-target-surface detector includes an infrared sensor configured to detect infrared rays from the detection position.

6: The autonomous electrical cleaning apparatus according to claim 1,
wherein the controller is configured to adjust the controlled variable of a rotation speed of the electric blower, when a type of a current surface to be cleaned that the suction port faces is different from a type of a next surface to be cleaned to be detected with the cleaning-target-surface detector and the apparatus-component moves by a distance from the detection position of the cleaning-target-surface detector.

7: The autonomous electrical cleaning apparatus according to claim 1,
wherein the controller is configured to adjust the controlled variable of at least one of a rotation speed and a rotation direction of the rotating-brush driver, when a type of a current surface to be cleaned that the rotating brush contacts is different from a type of a next surface to be cleaned to be detected with the cleaning-target-surface detector and the apparatus-component moves by a distance from the detection position of the cleaning-target-surface detector.

8: The autonomous electrical cleaning apparatus according to claim 1,
wherein the controller is configured to adjust the controlled variable of a rotation speed of the wheel driver, when a type of a current surface to be cleaned that the driving wheel contacts is different from a type of a next surface to be cleaned to be detected with the cleaning-target-surface detector and the apparatus-component moves by a distance from the detection position of the cleaning-target-surface detector.

9: The autonomous electrical cleaning apparatus according to claim 6,
wherein the controller is configured to adjust the controlled variable of a rotation speed of the electric blower, when a next surface to be cleaned to be detected with the cleaning-target-surface detector is rougher in terms of surface unevenness than a current surface to be cleaned that the suction port faces and the apparatus-component moves by a distance from the detection position of the cleaning-target-surface detector.

10: The autonomous electrical cleaning apparatus according to claim 6,
wherein the controller is configured to decrease a rotation speed of the electric blower, when a next surface to be cleaned to be detected with the cleaning-target-surface detector is finer in terms of surface unevenness than a current surface to be cleaned that the suction port faces and the apparatus-component moves by a distance from the detection position of the cleaning-target-surface detector.

11: The autonomous electrical cleaning apparatus according to claim 7,
wherein the controller is configured to increase the rotation speed of the rotating-brush driver, when the next surface to be cleaned detected is larger in friction coefficient than the current surface to be cleaned and the apparatus-component moves the distance from the detection position of the cleaning-target-surface detector.

12: The autonomous electrical cleaning apparatus according to claim 7,
wherein the controller is configured to decrease the rotation speed of the rotating-brush driver, when the next surface to be cleaned is smaller in friction coefficient than the current surface to be cleaned and the apparatus-component moves the distance from the detection position of the cleaning-target-surface detector.

13: The autonomous electrical cleaning apparatus according to claim 7,
wherein the controller is configured to reverse the rotation direction of the rotating brush when the rotating brush reaches the next surface to be cleaned.

14: The autonomous electrical cleaning apparatus according to claim 8,
wherein the controller is configured to decrease the rotation speed of the wheel driver, when the next surface to be cleaned is larger in friction coefficient than the current surface to be cleaned and the apparatus-component moves the distance from the detection position of the cleaning-target-surface detector.

15: The autonomous electrical cleaning apparatus according to claim 8,
wherein the controller is configured to increase the rotation speed of the wheel driver, when the next surface to be cleaned is smaller in friction coefficient than the current surface to be cleaned and the apparatus-component moves the distance from the detection position of the cleaning-target-surface detector.

16: The autonomous electrical cleaning apparatus according to claim 1, further comprising;
a pair of right and left second rotating brushes that are provided on the bottom face of the cleaner body and are disposed on respective right and left sides of the suction port; and
a pair of right and left second brush drivers that drive the corresponding right and left second rotating brushes,
wherein the controller is configured to vary at least one of a rotation speed of each of the second rotating brushes, a rotation direction of each of the second rotating brushes, and an elevation position of each of the second rotating brushes when the second rotating brushes reaches a next surface to be cleaned to be detected with the cleaning-target-surface detector.
